(19) United States
(12) Patent Application Publication
(10) Pub. No.: US 2015/0207860 A1
(43) Pub. Date: Jul. 23, 2015

(54) INFORMATION DISTRIBUTION SYSTEM, INFORMATION DISTRIBUTION SERVER, INFORMATION DISTRIBUTION METHOD, AND PROGRAM

(71) Applicant: NEC Corporation, Tokyo (JP)

(72) Inventors: Masaki Kan, Tokyo (JP); Yoshinori Nagata, Tokyo (JP)

(73) Assignee: NEC CORPORATION, Tokyo (JP)

(21) Appl. No.: 14/415,346

(22) PCT Filed: May 28, 2013
(86) PCT No.: PCT/JP2013/064745

§ 371 Date: Jan. 16, 2015

(30) Foreign Application Priority Data
Aug. 6, 2012 (JP) 2012-173801

(51) Int. Cl. H04L 29/08; H04L 12/18; G06F 17/30

(52) U.S. Cl. CPC H04L 67/10; G06F 17/30312; H04L 12/1886; H04L 12/1881

(57) ABSTRACT

An information distribution system for distributing information to terminals includes: information distribution destination determination means that uses location information that indicates the positions of terminals to determine terminals that are to be distribution destinations of information; first storage means that stores communication environment information that indicates communication networks that can be used by the terminals; second storage means for storing communication network status information that indicates the states of communication networks in each area; and selection means that uses the communication environment information and the communication network status information that are stored in the first and second storage means, respectively, to select communication networks when distributing information to distribution destination terminals.

### TECHNICAL FIELD

The present invention relates to technology for distributing information to terminals by way of a communication network.

### BACKGROUND ART

In recent years, information distribution systems have been proposed for distributing information by way of a communication network to mobile terminals such as vehicle terminals that are mounted in vehicles or portable terminals that are carried by people.

In this type of information distribution system, advertising information or information for supporting safe driving is distributed using location information of mobile terminals.

For example, Patent Document 1 discloses a technique of distributing information for supporting safe driving to a vehicle terminal that is mounted in a vehicle when the vehicle enters a specific area.

### LITERATURE OF THE PRIOR ART

### Patent Documents

Patent Document 1: Japanese Unexamined Patent Application Publication No. 2010-198260

### SUMMARY OF THE INVENTION

### Problem to be Solved by the Invention

Recently, however, it is becoming possible to use a plurality of communication networks in the distribution of information to mobile terminals. Examples of communication networks include mobile communication networks (such as 3G (3^{rd} Generation) networks or LTE (Long Term Evolution) networks), wireless LAN (Local Area Network) networks (such as WiFi networks that are based on, for example, IEEE (Institute of Electrical and Electronics Engineers) 802.11n or vehicle-to-vehicle and roadside-to-vehicle networks for automobiles based on IEEE 802.11p).

However, each communication network has its advantages and disadvantages. For example, a wireless LAN network has the disadvantage that a wireless LAN network base station can only be installed in limited locations and therefore cannot be used in many areas. A mobile communication network has the disadvantage that radio waves cannot reach certain areas (such as the interior of a tunnel). Due to these disadvantages, there will be areas in which information cannot be distributed to a mobile terminal when information distribution is performed through dependence on a single communication network.

In addition, increase in the use of mobile communication networks results in the large-scale use of the bandwidth of mobile communication, resulting in the possibility that stable communication cannot be secured or that the investment costs to businesses engaged in providing mobile communication network infrastructure will increase.

As a result, it is desirable to use appropriate communication networks in an information distribution system.

In addition, distribution modes for distributing information to all areas also include broadcast distribution or multicast distribution. However, this broadcast or multicast distribution distributes information to all mobile terminals located in an area and is therefore inappropriate for distributing information to only limited mobile terminals. For example, there are cases when the information reception process in requires payment by mobile terminals that are not the targets of information distribution.

As a result, it is also desirable to use appropriate broadcast distribution or multicast distribution in an information distribution system.

It is therefore an object of the present invention to provide a technology that can realize either the appropriate use of communication networks or the appropriate use of broadcast distribution or multicast distribution.

### Means for Solving the Problem

The information distribution system according to the present invention is an information distribution system that distributes information to terminals and that includes:

information distribution destination determination means that uses location information that indicates the positions of the terminals to determine terminals that are to be the distribution destinations of the information;

first storage means that stores communication environment information that indicates communication networks that the terminals can use;

second storage means that stores communication network status information that indicates the states of communication networks for each area; and

selection means that uses the communication environment information and the communication network status information that are stored in the first and second storage means, respectively, to select communication networks when distributing the information to the distribution destination terminals.

The information distribution server according to the present invention is an information distribution server that distributes information to terminals and that includes:

information distribution destination determination means that uses location information that indicates the positions of the terminals to determine terminals that are to be the distribution destinations of the information;

first storage means that stores communication environment information that indicates communication networks that the terminals can use;

second storage means that stores communication network status information that indicates the states of communication networks for each area; and

selection means that uses the communication environment information and the communication network status information that are stored in the first and second storage means, respectively, to select communication networks when distributing the information to the distribution destination terminals.

The information distribution method according to the present invention is an information distribution method that is realized by an information distribution server that distributes information to terminals and that includes:

storing in first storage means communication environment information that indicates communication networks that the terminals can use;

storing in second storage means communication network status information that indicates the states of communication networks for each area;

using location information that indicates positions of the terminals to determine terminals that are to be the distribution destinations of the information; and

using the communication environment information and the communication network status information that are stored in the first and second storage means, respectively, to select communication networks when distributing the information to the distribution destination terminals.

The program according to the present invention causes an information distribution server that distributes information to terminals to execute procedures of:

storing in first storage means communication environment information that indicates communication networks that the terminals can use;

storing in second storage means communication network status information that indicates the states of communication networks for each area;

using location information that indicates the positions of the terminals to determine terminals that are to be the distribution destinations of the information; and

using the communication environment information and the communication network status information that are stored in the first and second storage means, respectively, to select communication networks when distributing the information to the distribution destination terminals.

### Effect of the Invention

The present invention obtains the effect of enabling the appropriate use of communication networks to distribute information.

### BRIEF DESCRIPTION OF THE DRAWINGS

FIG. 1 is a block diagram showing the configuration of the information distribution system of an exemplary embodiment according to the present invention.

FIG. 2 is a view for describing an example of the operation of selecting a communication network and distribution mode when distributing information to a terminal in the information distribution system shown in FIG. 1.

FIG. 3 is a view for describing another example of the operation of selecting a communication network and a distribution mode when distributing information to a terminal in the information distribution system shown in FIG. 1.

FIG. 4 is a flow chart for describing the overall flow of operations of the information distribution system shown in FIG. 1.

FIG. 5 is a flow chart for describing the flow of operations of Step A2 shown in FIG. 4.

### MODE FOR CARRYING OUT THE INVENTION

A mode for carrying out the present invention is next described with reference to the accompanying drawings.

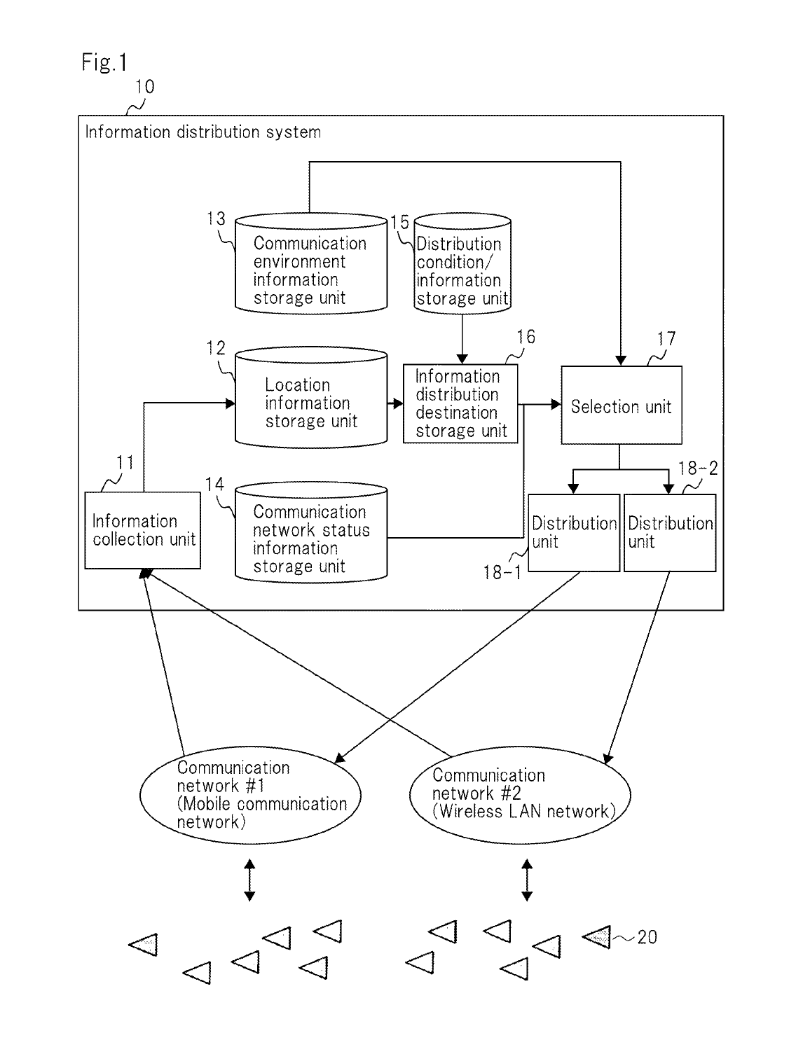

As shown in FIG. 1, information distribution system 10 of the present exemplary embodiment distributes information to terminals 20 by way of communication networks.

In the present exemplary embodiment, a case is described in which information is distributed to terminals 20 by way of two communication networks, communication network #1 and communication network #2, but the present invention is not limited to this form, and the number of communication networks may be three or more.

In the present exemplary embodiment, explanation regards a case in which communication network #1 is a mobile communication network (for example, a 3G network or LTE network) and communication network #2 is a wireless LAN network (for example a WiFi network based on IEEE 802.11n) but the present invention is not limited to this form, and the communication networks may be of other types. For example, a vehicle-to-vehicle and roadside-to-vehicle communication network based on IEEE 802.11p may be adopted as communication network #2, P2P communication may be carried out ad hoc between vehicles within a fixed area, and information may be distributed using a method referred to as GeoGraphic routing that delivers information to all vehicles within an area.

Information distribution system 10 includes: information collection unit 11, location information storage unit 12, communication environment information storage unit (first storage means) 13, communication network status information storage unit (second storage means) 14, distribution condition/information storage unit 15, information distribution destination storage unit 16, selection unit 17, and distribution units 18-1 and 18-2.

The constituent elements in information distribution system 10 may be arranged centrally in one server (information distribution server), or may be arranged dispersed among a plurality of servers.

Information collection unit 11 collects location information that indicates the positions of terminals 20 from terminals 20. In addition, when collecting information from terminals 20, information collection unit 11 also collects identifiers that identify terminals 20.

Location information storage unit 12 stores the location information of terminals 20 that was collected by information collection unit 11 in association with the identifiers of terminals 20. Location information storage unit 12 may store only the most recent location information, or may store a prescribed number of items of the most recent location information (including the latest location information).

Communication environment information storage unit 13 is a table that stores communication environment information that indicates communication networks that terminals 20 can use in association with the identifiers of terminals 20. In this case, the communication environment information of terminals 20 is assumed to be collected from carriers (telecommunications businesses).

Communication network status information storage unit 14 is a table that stores communication network status information that indicates the states of communication networks of areas in association with, for example, information indicating the range of each area (such as location information of the center point of an area, information of the radial distance from the center point, and any number of items of location information of the periphery of the area). For example, communication network status information is information that indicates communication networks for which communication is in effect in an area. It is here assumed that the communication network status information is collected from carriers.

Distribution condition/information storage unit 15 stores information that is distributed to terminals 20 in association with distribution conditions of the information (such as distribution areas in which the information is to be distributed).

Information distribution destination determination unit 16 uses the location information of terminals 20 that is stored in location information storage unit 12 to determine terminals 20 that are to be the distribution destinations of the information. More specifically, information distribution destination determination unit 16 first refers to distribution conditions that are stored in distribution condition/information storage unit 15 to determine one or more distribution areas. Information distribution destination determination unit 16 then uses the location information of terminals 20 that is stored in location information storage unit 12 to identify terminals 20 that are located in the above-described distribution areas that were determined and determines terminals 20 that were identified to be the distribution destinations.

Selection unit 17 uses the communication environment information that is stored in communication environment information storage unit 13 and the communication network status information that is stored in communication network status information storage unit 14 to select communication networks (mobile communication networks or wireless LAN networks) when distributing information to distribution destination terminals 20.

In addition, selection unit 17 uses, for example, the number of distribution destination terminals 20 that are located in the same areas as distribution destination terminal 20 to select the distribution mode (unicast distribution or broadcast distribution) when distributing information to distribution destination terminals 20.

A more specific explanation will be given hereinbelow regarding the method of selecting the communication network and distribution mode in selection unit 17.

Distribution unit 18-1 is provided to correspond to a mobile communication network and distributes information by unicast or by broadcast to terminals 20 by way of the mobile communication network in accordance with the selection result of selection unit 17.

Distribution unit 18-2 is provided to correspond to a wireless LAN network and distributes information by unicast or broadcast to terminals 20 by way of the wireless LAN network in accordance with the selection result of selection unit 17.

In the present exemplary embodiment, no particular limitations apply to terminals 20 as long as they are capable of using at least one of a mobile communication network and wireless LAN network and have the capability of acquiring location information of the current position and transmitting to information distribution system 10.

In addition, terminals 20 may be mobile terminals such as vehicle-mounted terminals that are mounted in vehicles or portable terminals that are carried by people, or may be terminals that are fixed at any site.

In addition, terminals 20 may be used in combination with other terminals that are able to use communication networks other than the communication networks of terminals 20. For example, if terminal 20 is a vehicle-mounted terminal capable of using a wireless LAN network, the other terminal may be a portable terminal such as a smartphone that can use a mobile communication network. In this case, the communication environment information of terminal 20 indicates that terminal 20 is able to use both the wireless LAN network and the mobile communication network.

In addition, terminals 20 may use GPS (Global Positioning System) to acquire location information, or may use the reception state of radio waves from a base station (a base station in a mobile communication network or a base station in a wireless LAN network) and the location information of the base station to acquire location information. Still further, terminals 20 may be provided with a construction that raises the accuracy of location information by using both of these functions.

The operation of information distribution system 10 of the present exemplary embodiment is next described.

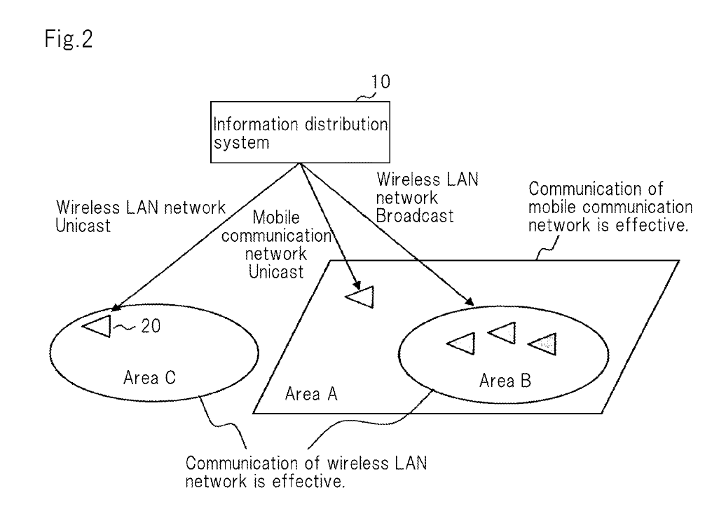

An example of the operation of selecting a communication network and distribution mode in information distribution system 10 is first described with reference to FIG. 2.

In FIG. 2, Area A is an area in which only communication of a mobile communication network is effective, Area B is an area in which communication of both the mobile communication network and a wireless LAN network is effective, and Area C is an area in which only communication of the wireless LAN network is effective.

It is here assumed that Areas A, B, and C are distribution areas, and terminals 20 located in Areas A, B, and C are to be determined as distribution destinations.

In addition, it is here assumed that in a distribution area in which communication of both the mobile communication network and wireless LAN network is effective, the wireless LAN network, which has a higher order of priority, is selected as the communication network, and the distribution mode is selected according to whether the number of distribution destination terminals 20 located in the distribution area surpasses or falls below a threshold value.

Only communication of the mobile communication network is effective in Area A, and the mobile communication network is therefore selected as the communication network. In addition, due to the low number of distribution destination terminals 20 in Area A (less than the threshold value), unicast distribution is selected as the distribution mode.

Only communication of the wireless LAN network is effective in Area C, and the wireless LAN network is therefore selected as the communication network. In addition, due to the low number of distribution destination terminals 20 in Area C (less than the threshold value), unicast distribution is selected as the distribution mode.

Communication of both the mobile communication network and the wireless LAN network is in effect in Area B, but the wireless LAN network, which has a higher order of priority, is selected in this case. In addition, due to the high number of distribution destination terminals 20 in Area B (equal to or greater than the threshold value), broadcast distribution is selected as the distribution mode.

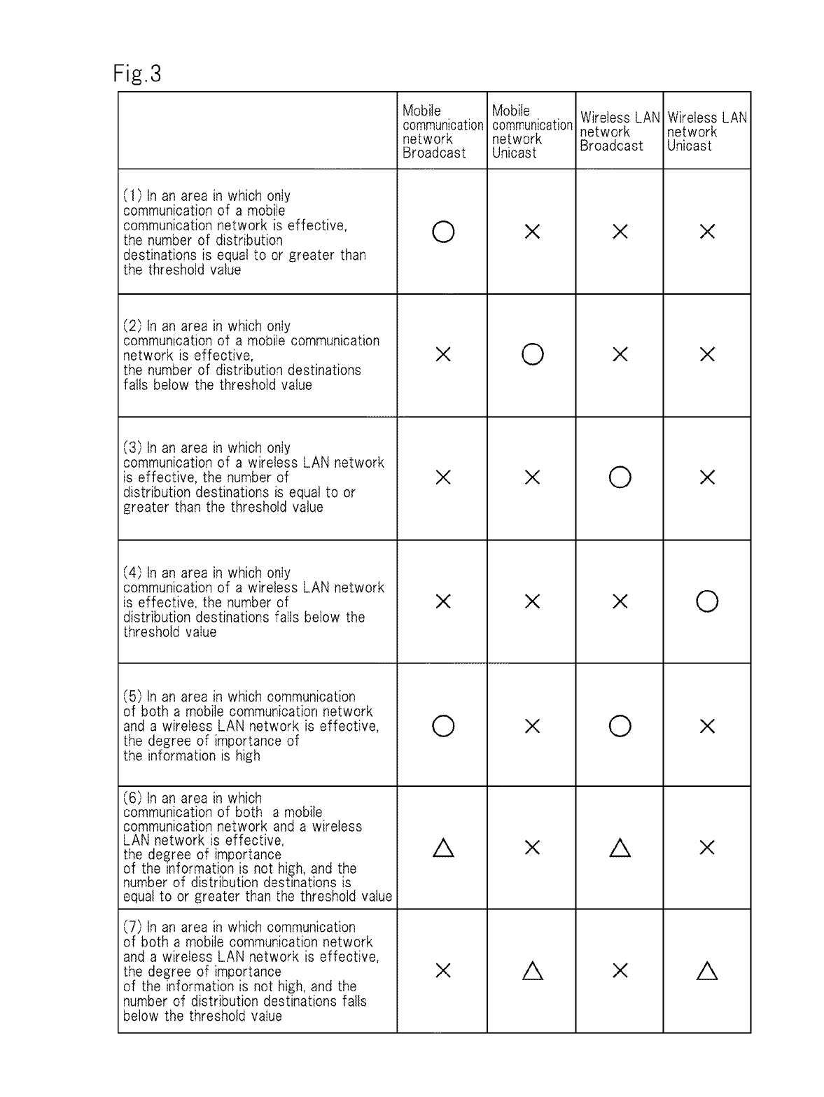

Another example of the operation of selecting communication networks and distribution mode in information distribution system 10 is next described with reference to FIG. 3.

In FIG. 3, (1)-(4) are examples of distribution areas in which communication of only a mobile communication network or a wireless LAN network is effective. In these cases, the communication network for which communication is effective is selected, and further, a distribution mode is selected according to whether the number of distribution destination terminals 20 in the distribution area surpasses or falls below a threshold value.

On the other hand, (5)-(7) are examples of distribution areas in which communication of both a mobile communication network and a wireless LAN network is effective. In these cases, if the degree of importance of the information is high, not only are both the mobile communication network and the wireless LAN network selected as the communication networks, but broadcast distribution is selected as the distribution mode. However, if the degree of importance of the information is not high, only the communication network having the higher order of priority among the mobile communication network and the wireless LAN network is selected, and further, the distribution mode is selected according to whether the number of distribution destination terminals 20 in the distribution area surpasses or falls below the threshold value.

In (6) and (7), “Δ” indicates that a communication network is selected if the order of priority of the communication network is high. For example, in (6), when selecting a communication network, a mobile communication network is selected if the order of priority of the mobile communication network is higher than that of the wireless LAN network, and the wireless LAN network is selected if the order of priority of the wireless LAN network is higher than that of the mobile communication network.

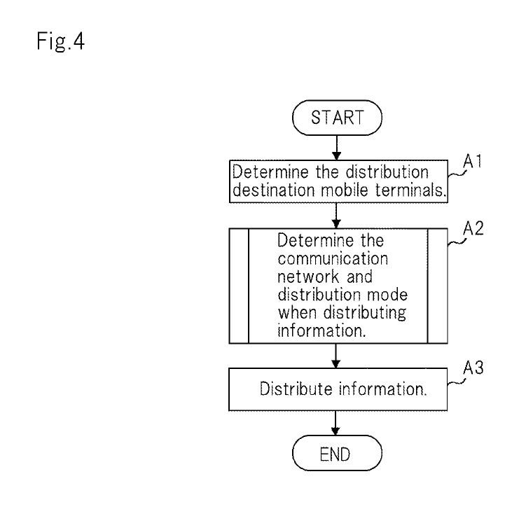

The overall flow of operations of information distribution system 10 is next described with reference to FIG. 4.

As shown in FIG. 4, information distribution destination determination unit 16 uses the location information of terminals 20 to determine terminals 20 to be the distribution destinations of information (Step A1). This distribution destination determination process by information distribution destination determination unit 16 is carried out in, for example, the following situations. Information distribution destination determination unit 16 uses all or a portion of the location information of terminals 20 that is stored in location information storage unit 12 to carry out the distribution destination determination process for each fixed time interval. Alternatively, when the location information of a fixed number of terminals 20 has been updated, information distribution destination determination unit 16 uses only the location information of the group of terminals 20 that have been updated to carry out the distribution destination determination process. In the latter case, location information storage unit 12 may be of a queue structure. Thus, the method of storing in location information storage unit 12 may of course vary according to the calculation method in the distribution destination determination process.

Selection unit 17 next uses the communication environment information and the communication network status information to both select the communication network when distributing information to distribution destination terminals 20 and to select the distribution mode (Step A2).

Distribution units 18-1 and 18-2 then distribute information by unicast or by broadcast to distribution destination terminals 20 by way of at least one of the mobile communication network and the wireless LAN network according to the selection result in selection unit 17 (Step A3).

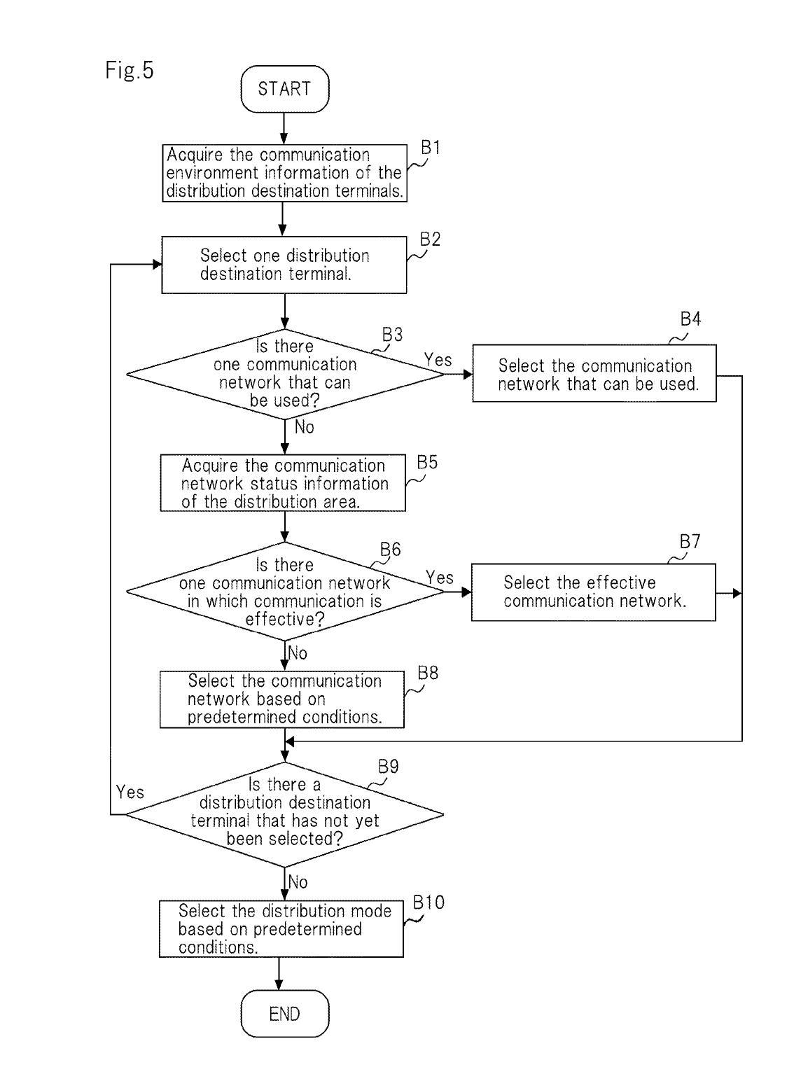

The flow of operations of Step A2 of FIG. 4 is next described with reference to FIG. 5.

As shown in FIG. 5, selection unit 17 first acquires from communication environment information storage unit 13 communication environment information of all terminals 20 that have been determined as distribution destinations of information (Step B1).

Selection unit 17 next selects one distribution destination terminal 20 (Step B2). This distribution destination terminal 20 that is selected is here referred to as “object terminal 20.”

Selection unit 17 then judges, based on the communication environment information of object terminal 20, whether the communication network, which object terminal 20 is capable of using, is either a mobile communication network or a wireless LAN network (Step B3).

In Step B3, if the communication network that object terminal 20 is capable of using is one network, selection unit 17 selects the communication network that can be used as the communication network when distributing information to object terminal 20 (Step B4).

On the other hand, in Step B3, if the communication network that object terminal 20 can use is not one network, selection unit 17 acquires from communication network status information storage unit 14 communication network status information of the distribution area in which object terminal 20 is located (Step B5).

Based on the communication network status information of the distribution area, selection unit 17 next judges whether the communication network for which communication is effective in the distribution area is one of a mobile communication network or a wireless LAN network (Step B6).

In Step B6, if the communication network for which communication is effective in the distribution area is one network, selection unit 17 selects the communication network for which communication is effective as the communication network when distributing information to object terminal 20 (Step B7).

On the other hand, in Step B6, if the communication network for which communication is effective in the distribution area is not one network, selection unit 17 selects a communication network based on predetermined conditions when distributing information to object terminal 20 (Step B8).

For example, when following the rules of the operation of FIG. 3, selection unit 17 selects both a mobile communication network and a wireless LAN network as the communication networks if the degree of importance of the information is high. Alternatively, if the degree of importance of the information is not high, selection unit 17 selects the communication network for which the order of priority is higher from among a mobile communication network and a wireless LAN network.

Selection unit 17 next judges whether there are still unselected communication networks among distribution destination terminals 20 (Step B9), and if there are unselected networks, returns to Step B2 to repeat the succeeding operations, and proceeds to Step B10 at the time that the communication networks of all distribution destination terminals 20 have been selected.

Selection unit 17 then selects the distribution mode when distributing information to distribution destination terminals 20 based on predetermined conditions (Step B10).

For example, when following the rules of the operations of FIG. 3, regarding distribution destination terminal 20 for which a mobile communication network or a wireless LAN network was selected as the communication network, selection unit 17 selects the distribution mode according to whether the number of distribution destination terminals 20 that are located in the same distribution area as that terminal 20 surpasses or falls below the threshold value. Further, regarding distribution destination terminal 20 for which both a mobile communication network and a wireless LAN network have been selected as the communication networks, selection unit 17 selects broadcast distribution as the distribution mode if the degree of importance of the information is high, and if the degree of importance of information is not high, selects the distribution mode according to whether the number of distribution destination terminals 20 that are located in the same distribution area as that terminal 20 surpasses or falls below the threshold value.

In the present exemplary embodiment as described hereinabove, the location information of terminals 20 is used to determine distribution destination terminals 20, and communication environment information that indicates communication networks that terminals 20 are capable of using and communication network status information that indicates the states of communication networks for each area are used to select communication networks when distributing information to distribution destination terminals 20.

As a result, not only can information be distributed to terminals 20 using appropriate communication networks, but excessive use of the bandwidth of a portion of communication networks can also be avoided.

Accordingly, the effect is obtained that communication network can be properly used to distribute information.

In the present exemplary embodiment, moreover, the effect is obtained that, because the distribution mode is selected using, for example, the number of distribution destination terminals 20 that are located in the same area as distribution destination terminal 20, broadcast distribution can be properly used to distribute information.

Although the present invention has been described hereinabove with reference to an exemplary embodiment, the present invention is not limited to the above-described exemplary embodiment. The configuration and details of the present invention are open to various modifications within the scope of the present invention that will be clear to one of ordinary skill in the art.

For example, although the location information of terminals 20 was stored in terminal location information storage unit 12 and then transferred to information distribution destination determination unit 16 in the above-described exemplary embodiment, terminal location information storage unit 12 may also be bypassed and the location information transferred directly to information distribution destination determination unit 16. In this case, terminal location information storage unit 12 is unnecessary.

Although it was assumed in the above-described exemplary embodiment that the communication environment information of terminals 20 was collected from carriers, a form may also be adopted in which information collection unit 11 collects the information from terminals 20 themselves, or the terminal information and information of communication environments in which use is possible are registered, for example, in advance at the time of registering the users of the information distribution system.

Further, although the communication network status information was assumed to be collected from carriers in the above-described exemplary embodiment, information collection unit 11 may also collect the information from terminals 20. The communication network status information in this case is, for example, information indicating whether radio waves from each communication network reach terminals 20.

Still further, although selection unit 17 used, in addition to communication environment information and communication network status information, both the degree of importance of the information and the order of priority of the communication networks to select communication networks in the above-described exemplary embodiment, there is no need to use both of these types of information and at least one may be used.

In addition, although selection unit 17 used both the number of distribution destination terminals 20 that are located in the same area as distribution destination terminal 20 and the degree of importance of the information to select the distribution mode in the above-described exemplary embodiment, there is no need to use both of these types of information, and at least one may be used.

Although information collection unit 11 collected identifiers of terminals 20 when collecting location information from terminals 20 in the above-described exemplary embodiment, information collection unit 11 may further collect identifiers that identify the base stations (base stations in a mobile communication network or base stations in a wireless LAN network) to which terminals 20 are connected. Terminals 20 in actuality are connected to base stations and communicate with information distribution system 10 by way of base stations, and the identifiers of the base stations can be acquired by terminals 20 at the time of establishing connections with the base stations. As a result, information collection unit 11 collects the identifiers of the base stations to which terminals 20 are connected and stores the identifiers in a storage unit (third storage means) in association with the identifiers of terminals 20. This storage unit may be realized by an existing storage unit or provided separately. Then, when the communication network that was selected by selection unit 17 for distribution destination terminal 20 matches with the communication network to which the base station that is placed in association with the distribution destination terminal 20 belongs, distribution units 18-1 and 18-2 distribute the information by way of the base station that was placed in association with that distribution destination terminal 20. In this way, information can be distributed from the base station that is located closest within the communication network to distribution destination terminal 20, whereby the effects are obtained in which reception quality is improved and transfer time is reduced.

In addition, the communication network that is used at the time of reporting information such as location information from terminals 20 to information distribution system 10 can be selected by any method. For example, a method is possible in which orders of priority are assigned to communication networks, and at the time of reporting information, terminal 20 selects the communication network that can be used in the order of priority. In addition, a construction may be provided to terminal 20 such that the order of priority of a particular communication network is lowered when the amount of use of bandwidth in a fixed interval of that communication network exceeds a particular threshold value.

In addition, terminal 20 may hold geographical information and communication network status information and may select the communication network to be used at the time of reporting information based on the location of terminal 20. By adopting this method, the process of checking all communication networks to determined usability can be reduced. Alternatively, similarly holding geographical information and communication network status information makes possible, when an area exists in the vicinity of terminal 20 in which communication is effective for a communication network having a higher order of priority, the reporting of location information when terminal 20 enters that area. Adopting this form enables a reduction of the amount of use of a communication network by which communication is to be avoided due to reasons such as usage fees or the bandwidth environment.

Finally, the methods carried out in information distribution system 10 can be applied to a program that is executed by a computer. This computer is, for example, a server (information distribution server) that centralizes the constituent elements in information distribution system 10. In addition, this program can be stored on a recording medium and can be provided to the outside by way of a network.

This application claims the benefits of priority based on Japanese Patent Application No. 2012-173801 for which application was submitted on Aug. 6, 2012 and incorporates by citation all of the disclosures of that application.

1. An information distribution system that distributes information to terminals, comprising:
an information distribution destination determination unit that uses location information that indicates the positions of said terminals to determine terminals that are to be the distribution destinations of said information;
a first storage unit that stores communication environment information that indicates communication networks that said terminals can use;
a second storage unit that stores communication network status information that indicates the states of communication networks for each area; and
a selection unit that uses said communication environment information and said communication network status information that are stored in said first and second storage unit, respectively, to select communication networks when distributing said information to said distribution destination terminals.

2. The information distribution system as set forth in claim 1, wherein said selection unit further uses at least one from among the degree of importance of said information and the order of priority of said communication networks to select communication networks when distributing said information to said distribution destination terminals.

3. The information distribution system as set forth in claim 1, wherein said selection unit uses at least one from among the number of distribution destination terminals that are located in the same area as said distribution destination terminal and the degree of importance of said information to select a distribution mode when distributing said information to said distribution destination terminals.

4. The information distribution system as set forth in claim 1, further comprising a collection unit that collects said location information from said terminals;
wherein said information distribution destination determination unit uses said location information that was collected by said collection unit to determine said distribution destination terminals.

5. The information distribution system as set forth in claim 4, wherein:
said collection unit collects said communication environment information from said terminals; and
said first storage unit stores said communication environment information that was collected by said collection unit.

6. The information distribution system as set forth in claim 4, wherein:
said collection unit collects said communication network status information from said terminals; and
said second storage unit stores said communication network status information that was collected by said collection unit.

7. The information distribution system as set forth in claim 4, wherein:
said collection unit, at the time of collecting said location information from said terminals, collects identifiers of said terminals and identifiers of base stations to which said terminals are connected; and
said information distribution system further comprises:
a third storage unit that stores identifiers of said terminals in association with identifiers of base stations to which said terminals are connected; and
a distribution unit that, when a communication network that was selected by said selection unit for said distribution destination terminal matches a communication network to which the base station that is placed in association with the distribution destination terminal belongs, distributes information by way of the base station that was placed in association with the distribution destination terminal.

8. An information distribution server that distributes information to terminals, comprising:
an information distribution destination determination unit that uses location information that indicates the positions of said terminals to determine terminals that are to be distribution destinations of said information;
a first storage unit that stores communication environment information that indicates communication networks that said terminals can use;
a second storage unit that stores communication network status information that indicates the states of communication networks for each area; and
a selection unit that uses said communication environment information and said communication network status information that are stored in said first and second storage unit, respectively, to select communication networks when distributing said information to said distribution destination terminals.

9. An information distribution method that is realized by an information distribution server that distributes information to terminals, comprising:
storing in a first storage unit communication environment information that indicates communication networks that said terminals can use;
storing in a second storage unit communication network status information that indicates the states of communication networks for each area;
using location information that indicates positions of said terminals to determine terminals that are to be distribution destinations of said information; and
using said communication environment information and said communication network status information that are stored in said first and second storage unit, respectively, to select communication networks when distributing said information to said distribution destination terminals.

10. A non transitory computer readable record medium on which a program for causing an information distribution server that distributes information to terminals to execute procedures of:
storing in a first storage unit communication environment information that indicates communication networks that said terminals can use;
storing in a second storage unit communication network status information that indicates the states of communication networks for each area;
using location information that indicates the positions of said terminals to determine terminals that are to be the distribution destinations of said information; and
using said communication environment information and said communication network status information that are stored in said first and second storage unit, respectively, to select communication networks when distributing said information to said distribution destination terminals.
